(19) United States
(12) Patent Application Publication
(10) Pub. No.: US 2026/0141258 A1
(43) Pub. Date: May 21, 2026

(54) METHOD AND APPARATUS FOR DATASET DISTILLATION

(71) Applicants: SAMSUNG ELECTRONICS CO.,LTD., Suwon-si (KR); Korea Advanced Institute Science and Technology, Suwon-si (KR)

(72) Inventors: Seongeun KIM, Suwon-si (KR); Donghyeok SHIN, Daejeon (KR); Wanmo KANG, Daejeon (KR); IL-chul MOON, Daejeon (KR); HeeSun BAE, Daejeon (KR); Gyuwon SIM, Daejeon (KR)

(73) Assignees: SAMSUNG ELECTRONICS CO.,LTD., Daejeon (KR); Korea Advanced Institute Science and Technology, Suwon-si (KR)

(21) Appl. No.: 19/205,310

(22) Filed: May 12, 2025

(30) Foreign Application Priority Data
Nov. 21, 2024 (KR) 10-2024-0167514
Jan. 6, 2025 (KR) 10-2025-0001798

(51) Int. Cl. G06N 3/096

(52) U.S. Cl. CPC G06N 3/096

(57) ABSTRACT

A method and apparatus for dataset distillation are provided. The method includes: obtaining an original coordinate set including coordinates of original data included in an original dataset; generating first test data included in a test dataset corresponding to a first neural field model from among a plurality of neural field models by providing the original coordinate set to the first neural field model; obtaining a first result by providing at least a portion of the original dataset to a neural test model; obtaining a second result by providing at least a portion of the test dataset including the first test data to the neural test model; determining a distillation loss based on the first result and the second result; and training the plurality of neural field models based on the distillation loss.

### CROSS-REFERENCE TO RELATED APPLICATION

This application claims priority from Korean Patent Application No. 10-2024-0167514, filed on Nov. 21, 2024, and Korean Patent Application No. 10-2025-0001798, filed on Jan. 6, 2025, in the Korean Intellectual Property Office, the disclosures of which are incorporated by reference herein in their entireties.

### BACKGROUND

### 1. Field

Methods and apparatuses consistent with embodiments of the disclosure relate to dataset distillation.

### 2. Description of Related Art

Dataset distillation may refer to a process for generating a small-scale distilled dataset based on a large-scale original dataset, and may be used, for example, to train an artificial intelligence (AI) model. A distilled dataset may include essential or important information of an original dataset for training an AI model, so that the distilled dataset may be used to train an AI model instead of the original dataset. By replacing an original dataset with a distilled dataset, the computational costs and storage costs used to train an AI model may be reduced in comparison with a large-scale original dataset.

### SUMMARY

One or more embodiments can address at least the above problems and/or disadvantages and other disadvantages not described above. Also, the embodiments are not required to overcome the disadvantages described above, and an embodiment cannot overcome any of the problems described above.

In accordance with an aspect of the disclosure, a distillation method includes: obtaining an original coordinate set including coordinates of original data included in an original dataset; generating first test data included in a test dataset corresponding to a first neural field model from among a plurality of neural field models by providing the original coordinate set to the first neural field model; obtaining a first result by providing at least a portion of the original dataset to a neural test model; obtaining a second result by providing at least a portion of the test dataset including the first test data to the neural test model; determining a distillation loss based on the first result and the second result; and training the plurality of neural field models based on the distillation loss.

The generating of the first test data may include: generating a first data value corresponding to a first coordinate from among the original coordinate set by providing the first coordinate to the first neural field model.

The distillation method may further include: generating a distilled dataset including distilled data corresponding to each neural field model from among the plurality of neural field models by providing, to the plurality of neural field models, an input coordinate set selected from among a plurality of candidate coordinate sets including the original coordinate set.

The generating of the distilled dataset may include: generating a data value corresponding to a second coordinate included in the input coordinate set by providing the second coordinate to the plurality of neural field models.

A number of data values included in each piece of distilled data included in the distilled dataset may correspond to a number of coordinates included in the input coordinate set.

A number of pieces of distilled data included in the distilled dataset may be equal to a number of the plurality of neural field models.

The distillation method may further include: generating second test data corresponding to a second neural field model from among the plurality of neural field models by providing the original coordinate set to the second neural field model.

In accordance with an aspect of the disclosure, a training method includes: obtaining an original coordinate set including coordinates of original data included in an original dataset; generating first test data included in a test dataset corresponding to a first neural field model from among a plurality of neural field models by providing the original coordinate set to the first neural field model; obtaining a first result by providing at least a portion of the original dataset to a neural test model; obtaining a second result by providing at least a portion of the test dataset including the first test data to the neural test model; determining a distillation loss based on the first result and the second result; training the plurality of neural field models based on the distillation loss; generating a distilled dataset including distilled data corresponding to each neural field model from among the plurality of neural field models by providing, to the plurality of neural field models, an input coordinate set from among a plurality of candidate coordinate sets including the original coordinate set; and training a target model based on the distilled dataset.

The generating of the first test data may include:
generating a data value corresponding to a first coordinate included in the original coordinate set by providing the first coordinate to the first neural field model.

The generating of the distilled dataset may include: generating a data value corresponding to a second coordinate included in the input coordinate set by providing the second coordinate to the plurality of neural field models.

A number of data values included in each piece of distilled data included in the distilled dataset may correspond to a number of coordinates included in the input coordinate set.

A number of pieces of distilled data included in the distilled dataset may be equal to a number of the plurality of neural field models.

The training method may further include: generating second test data corresponding to a second neural field model from among the plurality of neural field models by providing the original coordinate set to the second neural field model.

In accordance with an aspect of the disclosure, an electronic device includes: one or more processors; and a memory configured to store instructions executable by the one or more processors, wherein, the instructions, when executed by the one or more processors, cause the electronic device to: obtain an original coordinate set including coordinates of original data included in an original dataset; generate first test data included in a test dataset corresponding to a first neural field model from among a plurality of neural field models by providing the original coordinate set to the first neural field model; obtain a first result by providing at least a portion of the original dataset to a neural test model, obtain a second result by providing at least a portion of the test dataset including the first test data to the neural test model; determine a distillation loss based on the first result and the second result, and train the plurality of neural field models based on the distillation loss.

To generate the first test data, the instructions, when executed by the one or more processors, may further cause the electronic device to:
generate a data value corresponding to a first coordinate included in the original coordinate set by providing the first coordinate to the first neural field model.

The instructions, when executed by the one or more processors, may further cause the electronic device to: generate a distilled dataset including distilled data corresponding to each neural field model from among the plurality of neural field models by providing, to the plurality of neural field models, an input coordinate set from among candidate coordinate sets including the original coordinate set.

To generate the distilled dataset, the instructions, when executed by the one or more processors, may further cause the electronic device to: generate a data value of the distilled dataset corresponding to a second coordinate included in the input coordinate set by providing the second coordinate to the plurality of neural field models.

A number of data values included in each piece of distilled data included in the distilled dataset may correspond to a number of coordinates included in the input coordinate set.

A number of pieces of distilled data included in the distilled dataset may be equal to a number of the plurality of neural field models.

The instructions, when executed by the one or more processors, may further cause the electronic device to: generate second test data of the test dataset corresponding to a second neural field model from among the plurality of neural field models by providing the original coordinate set to the second neural field model.

### BRIEF DESCRIPTION OF THE DRAWINGS

The above and/or other aspects, features, and advantages of certain embodiments of the present disclosure will be more apparent from the following description, taken in conjunction with the accompanying drawings, in which:

FIG. 1 is a diagram illustrating an example of a process for training the same artificial intelligence (AI) model using an original dataset and a distilled dataset, according to an embodiment;

FIG. 2 is a flowchart illustrating an example of a process for training a plurality of neural field models, according to an embodiment;

FIG. 3 is a diagram illustrating an example of a process for training a plurality of neural field models, according to an embodiment;

FIG. 4 is a diagram illustrating an example of a process for generating test data based on the type of original data, according to an embodiment;

FIG. 5 is a flowchart illustrating an example of a method for training an AI model using a distilled dataset, according to an embodiment;

FIG. 6 is a diagram illustrating an example of candidate coordinate sets, according to an embodiment;

FIG. 7 is a flowchart illustrating an example of a method of dataset distillation, according to an embodiment; and

FIG. 8 is a block diagram illustrating a configuration of an electronic device to distill a dataset, according to an embodiment.

### DETAILED DESCRIPTION

The following detailed structural or functional description is provided as an example only and various alterations and modifications can be made to the embodiments. Here, the embodiments are not construed as limited to the disclosure and should be understood to include all changes, equivalents, and replacements within the idea and the technical scope of the disclosure.

Terms such as first, second, and the like, may be used herein to describe components. These terms are not used to define an essence, order or sequence of a corresponding component, and are instead used merely to distinguish the corresponding component from one or more other components. For example, a first component may be referred to as a second component, and similarly the second component may also be referred to as the first component.

It should be noted that if a first component is described as being “connected”, “coupled”, or “joined” to a second component, this may mean that a third component may be connected, coupled, or joined between the first and second components, or that the first component are directly connected, coupled, or joined to the second component.

As used herein, the singular forms “a”, “an”, and “the” may include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “at least one of A and B”, “at least one of A, B, or C,” and the like, may include any one of the items listed together in the corresponding one of the phrases, or all possible combinations thereof.

As used herein, when an action or operation is referred to as occurring “in response to” an event or occurrence, this may mean that action or operation occurs directly or indirectly in response to or based on the event or occurrence.

Unless otherwise defined, all terms, including technical and scientific terms, used herein have the same meaning as commonly understood by one of ordinary skill in the art to which this disclosure pertains. Terms, such as those defined in commonly used dictionaries, are to be interpreted as having a meaning that is consistent with their meaning in the context of the relevant art, and are not to be interpreted in an idealized or overly formal sense unless expressly so defined herein.

Hereinafter, embodiments are described in detail with reference to the accompanying drawings. When describing the embodiments with reference to the accompanying drawings, like reference numerals refer to like elements and a repeated description related thereto may be omitted.

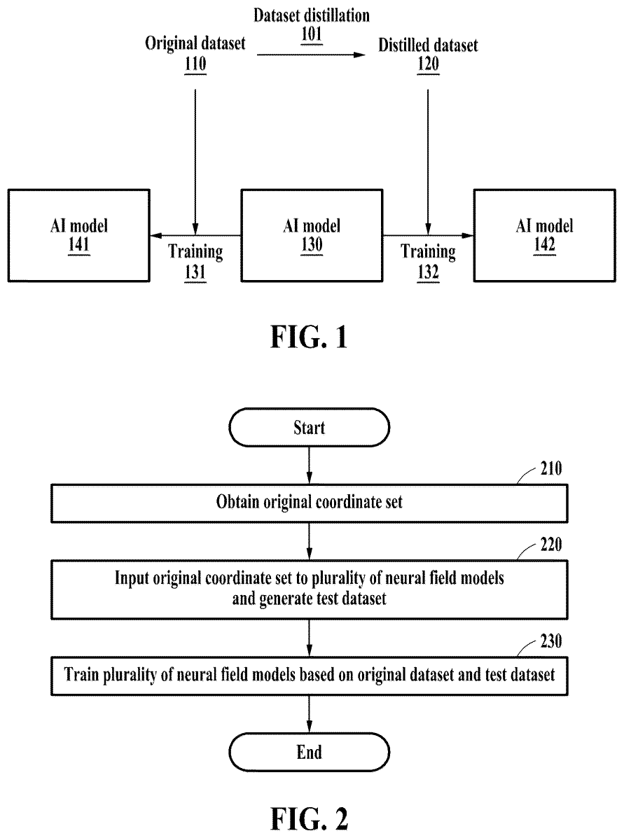

FIG. 1 is a diagram illustrating an example of a process for training an artificial intelligence (AI) model using an original dataset and a distilled dataset, according to an embodiment. Referring to FIG. 1, a training procedure 131 may be performed on an AI model 130 using an original dataset 110 to obtain or generate an AI model 141, and a training procedure 132 may be performed on the AI model 130 using a distilled dataset 120 (examples of which are described below) to obtain or generate an AI model 142. The AI model 130 may correspond to a state before the training procedure 131 and the training procedure 132, the AI model 141 may correspond to a state after the training procedure 131, and the AI model 142 may correspond to a state after the training procedure 132. The AI model 130 may be any type of AI or machine learning model, for example any type of deep learning-based neural network model. For example, the AI model 130 may correspond to an object classification model, an object detection model, an image segmentation model, etc. The object classification model may determine the class of an object in an input image. Hereinafter, an example is described in which the AI model 130 is an object classification model, but embodiments are not limited thereto.

The original dataset 110 may include large-scale original data. The large-scale original data may be data for training the AI model 130. For example, when the AI model 130 is the object classification model, original data included in the original dataset 110 may include a class label and image data for training the AI model 130. The AI model 130 may perform object classification based on the image data, and may be trained based on a loss between the object classification result and the class label (e.g., a loss that may be calculated or determined based on the object classification result and the class label). The AI model 130 may be any model among the AI models that may be trained using the original dataset 110. For example, when the original dataset 110 is a dataset for training the object classification model, the AI model 130 may be any object classification model.

The AI model 141 may be an AI model that is obtained after the training procedure 131 is performed on the AI model 130 using the original dataset 110. In some embodiments, AI model 130 may exhibit higher performance, because the AI model 130 was trained using various pieces of data. As the number of pieces of original data included in the original dataset 110 increases, the AI model 141 may higher performance after training. For example, an AI model 141 that is trained based on an original dataset 110 including 10,000 pieces of original data may have a higher performance than an AI model 141 that is trained based on an original dataset 110 including 1,000 pieces of original data.

As the number of pieces of original data of the original dataset 110 increases, the computational costs and storage costs of the training procedure 131 may increase. To reduce computational costs and storage costs occurring while the AI model 130 is trained, a distilled dataset 120 based on the original dataset 110 may be generated. The distilled dataset 120 may be generated by performing a dataset distillation process 101 on the original dataset 110. The dataset distillation process 101 may correspond to a process for generating a small number of pieces of data to train the AI model 130.

The distilled dataset 120 may include a plurality of pieces of distilled data. The plurality of pieces of distilled data may be pieces of data for training the AI model 130. Each piece of distilled data included in the distilled dataset 120 may be synthetic data that is not included in the original dataset 110. However, embodiments are not limited thereto, and in some embodiments only some of the pieces of data included in the distilled dataset 120 may be synthetic data, and other pieces of data may be, for example, original data that is included in the original dataset. The distilled dataset 120 may be a dataset including essential or important information of the original dataset 110 for training the AI model 130. The AI model 142 may be an AI model that is obtained after the training procedure 132 is performed on the AI model 130 using the distilled dataset 120. The AI model 142 may exhibit substantially similar performance to the AI model 141. Accordingly, the distilled dataset 120 may replace the original dataset 110.

A number of pieces of data included in the distilled dataset 120 may be less than a number of pieces of data included in the original dataset 110. For example, when the number of pieces of image data included in the original dataset 110 is 10,000, the number of pieces of image data included in the distilled dataset 120 may be 10. Because the number of pieces of distilled data included in the distilled dataset 120 is less than the number of pieces of original data included in the original dataset 110, the training procedure 132 performed on the AI model 130 using the distilled dataset 120 may be associated with lower computational costs than the training procedure 131 performed on the AI model 130 using the original dataset 110. In addition, because the distilled dataset 120 may replace the original dataset 110, storage costs may be reduced when the distilled dataset 120 is generated.

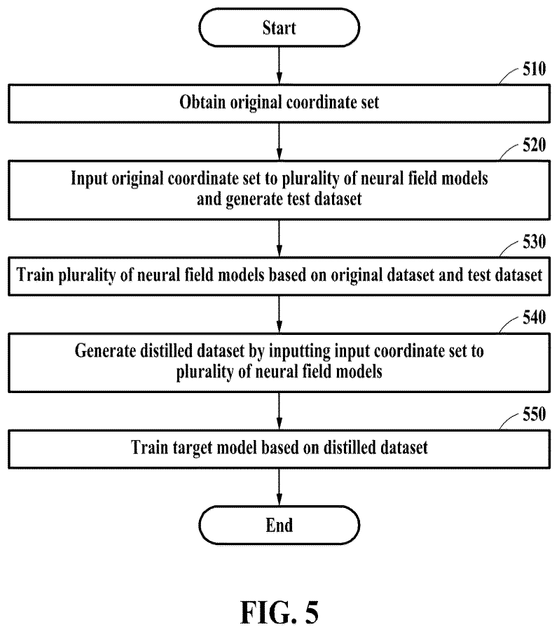

The dataset distillation process 101 may include a process for training one or more neural field models. In the process for training the one or more neural field models, an original coordinate set of the original dataset 110 may be used. An example of the process for training the one or more neural field models (e.g., a plurality of neural field models) is described below with reference to FIG. 2. The dataset distillation process 101 may include a process for inputting an input coordinate set to a plurality of trained neural field models and generating the distilled dataset 120. An example of a process for generating the distilled dataset 120 is described below with reference to FIG. 5.

FIG. 2 is a flowchart illustrating an example of a process for training a plurality of neural field models, according to an embodiment. Referring to FIG. 2, at operation 210, an original coordinate set may be obtained from an original dataset. The original coordinate set may include all coordinates of a coordinate system of original data of the original dataset. The original coordinate set may be expressed as a set of lattice points. Each coordinate included in the original data of the original coordinate set may correspond to a location at which information of the original data is stored. The original coordinate set may only include a coordinate value that designates a location and may not include a data value of the location. The original coordinate set may be expressed as shown in Equation 1 below.

$$C = \{ ( {i}_{1} , {i}_{2} , … , {i}_{n} ) \vert {i}_{k} ∈ \{ 0 , 1 , … , {N}_{k} \} , ∀ k = 1 , 2 , … , n \} \qquad ( Equation 1 )$$

In Equation 1 above, C may denote the original coordinate set and n may denote the number of dimensions forming the original data of the original dataset. According to embodiments, n may be an integer that is greater than or equal to 2. For example, n may be 2 when the original data of the original dataset is image data corresponding to two-dimensional (2D) data. In addition, iₖ may denote a k-th element of each coordinate of the original coordinate set. For example, iₖ may be an element corresponding to a k-th dimension forming the original data. According to embodiments, iₖ may have one value from 0 to Nₖ. The number of values that iₖ may have may be the number of locations where the information of the original data may be stored in the k-th dimension. For example, when the original data of the original dataset is image data having a resolution of 1920×1080, the number of locations at which the information of the original data may be stored in a first dimension and a second dimension may be 1,920 and 1,080, respectively, and N₁ and N₂ may be 1,919 and 1,079, respectively.

The process for obtaining the original coordinate set may not use additional pieces of information other than the original dataset. Because the original coordinate set may correspond to a space in which the original data may be stored, the original coordinate set may be simply or easily obtained from the original dataset. Because the original coordinate set may be simply obtained, a process for optimizing the original dataset and additional storage costs to store the original coordinate set may not be used.

At operation 220, a test dataset may be generated by inputting or providing the original coordinate set to a plurality of neural field models. The plurality of neural field models may be models configured to receive a coordinate set as an input. For example, the plurality of neural field models may be models configured to receive each coordinate of the coordinate set. For example, the plurality of neural field models may be deep learning-based neural network models (e.g., multi-layer perceptron (MLP) models) configured to receive each coordinate of the coordinate set. The plurality of neural field models may be or may include one or more data values corresponding to each coordinate included in the input coordinate set.

Each neural field model from among the plurality of neural field models may receive the original coordinate set as an input. For example, each neural field model from among the plurality of neural field models may receive each coordinate of the original coordinate set. Each neural field model from among the plurality of neural field models may generate test data based on the input original coordinate set. Each neural field model from among the plurality of neural field models may output one or more data values corresponding to each coordinate, based on each coordinate included in the input original coordinate set. Each neural field model from among the plurality of neural field models may generate test data corresponding to the original coordinate set. The test data corresponding to the original coordinate set may include one or more data values corresponding to each coordinate of the original coordinate set.

The test data may be or may include data used to train the plurality of neural field models. Each neural field model from among the plurality of neural field models may generate one piece of test data corresponding to the original coordinate set. The test data may be data that is temporarily generated to train the plurality of neural field models. The test dataset may include a plurality of pieces of test data corresponding to the original coordinate set.

At operation 230, the plurality of neural field models may be trained based on the original dataset and the test dataset. Training the plurality of neural field models may refer to training parameters of the plurality of neural field models. The plurality of neural field models may be trained such that the difference in performance between an AI model trained using the original dataset and an AI model trained using the test dataset is reduced. A neural test model may be used to train the plurality of neural field models.

The neural test model may be or may include any deep learning-based neural network model for testing whether the test dataset functions similarly to the original dataset as a training dataset. Distillation loss may be determined based on a result generated by inputting or providing the original dataset to the neural test model and a result generated by inputting or providing the test dataset to the neural test model. The distillation loss may be a loss for training the plurality of neural field models. Each neural field model included in the plurality of neural field models may be trained based on the distillation loss.

In an embodiment, the neural test model may be a feature extractor model that extracts features of the original dataset and the test dataset. For example, the feature extractor may be a neural encoder. The neural test model may be initialized randomly to compare the features of the original dataset with the features of the test dataset. The plurality of neural field models may be trained to reduce the difference between a feature distribution of the original dataset and a feature distribution of the test data. For example, the distillation loss may be determined based on the difference between an average of the features output by inputting the original dataset to the feature extractor and an average of the features output by inputting the test dataset to the feature extractor.

In an embodiment, the neural test model may be any model that may be trained using the original dataset. For example, when the original dataset is a dataset for training an object classification model, the neural test model may be any object classification model. The neural test model may be a randomly initialized model to compare a training procedure or training process based on the original dataset, with a training procedure or training process based on the test dataset. The plurality of neural field models may be trained such that the difference between the process for training the neural test model using the original dataset and the process for training the neural test model using the test dataset is reduced. For example, the distillation loss may be determined based on the difference between a gradient of loss determined in the process for training the neural test model using a gradient descent method based on the original dataset and a gradient of loss determined in the process for training the neural test model using the same gradient descent method based on the test dataset. For example, the loss of the neural test model may be an average or a mean squared error (MSE) of a cross-entropy of the input dataset calculated based on an output value corresponding to each piece of data of the dataset that is input to the neural test model and a ground truth (GT) value corresponding to each piece of data of the input dataset. For example, the GT value corresponding to each piece of data of the input dataset may be a value corresponding to a class label corresponding to each piece of data of the dataset when the neural test model is the object classification model.

The distillation loss may be determined based on a result generated by inputting at least a portion of the original dataset to the neural test model and a result generated by inputting at least a portion of the test dataset to the neural test model. For example, the distillation loss may be determined based on a result generated by inputting half of the data from the original dataset to the neural test model and a result generated by inputting half of the data from the test dataset to the neural test model.

For example, when the original dataset is a dataset for training the object classification model, the distillation loss may be determined for each class of an image, and a portion of the original dataset and a portion of the test dataset corresponding to the classes of the image may be used to determine the distillation loss for each class of the image. At least a portion of the original dataset and at least a portion of the test dataset may correspond to mini batches (e.g., small batches) of the original dataset and the test dataset, respectively.

Because the original coordinate set obtained at operation 210 may not generate additional storage costs, the saved storage costs may be allocated to the parameters from among the plurality of neural field models. Accordingly, the plurality of neural field models may output various values. Outputting various values may refer to having high expressiveness. Due to the high expressiveness of the plurality of neural field models, the value of the distillation loss may decrease. Accordingly, due to the high expressiveness of the plurality of neural field models, the plurality of neural field models trained at operation 230 may output, as training data, a dataset that may exhibit performance that is more similar to the original dataset.

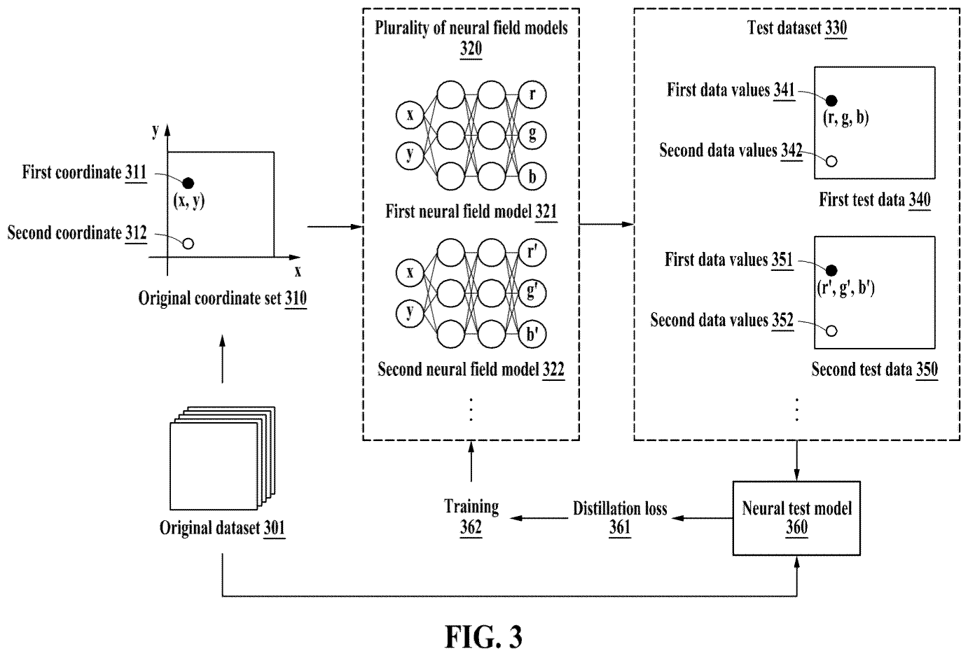

FIG. 3 is a diagram illustrating an example of a process for training a plurality of neural field models, according to an embodiment. Referring to FIG. 3, an original coordinate set 310 may be obtained from an original dataset 301. The original coordinate set 310 may include coordinates of the original dataset 301. The original coordinate set 310 may include a plurality of coordinates. For example, the plurality of coordinates of the original coordinate set 310 may include a first coordinate 311 and a second coordinate 312.

A plurality of neural field models 320 may receive the original coordinate set 310. For example, a first neural field model 321 and a second neural field model 322 may each receive the original coordinate set 310. Specifically, each neural field model from among the plurality of neural field models 320 may receive each coordinate of the original coordinate set 310. For example, the first neural field model 321 and the second neural field model 322 may each receive the first coordinate 311 (e.g., an (x, y) value). For example, the first neural field model 321 and the second neural field model 322 may each receive the second coordinate 312.

In response to an input of the original coordinate set 310, the plurality of neural field models 320 may generate a test dataset 330. For example, in response to the input of the original coordinate set 310, each neural field model from among the plurality of neural field models 320 may generate pieces of test data corresponding to each neural field model. For example, in response to the input of the original coordinate set 310, the first neural field model 321 may generate first test data 340 corresponding to the first neural field model 321. For example, in response to the input of the original coordinate set 310, the second neural field model 322 may generate second test data 350 corresponding to the second neural field model 322.

In response to an input of each coordinate of the original coordinate set 310, the plurality of neural field models 320 may generate data values corresponding to each coordinate of the original coordinate set 310. In response to the input of each coordinate of the original coordinate set 310, each neural field model from among the plurality of neural field models 320 may generate one or more data values of pieces of test data corresponding to each neural field model. For example, in response to an input of the first coordinate 311, the first neural field model 321 may generate first data values 341 corresponding to the first coordinate 311. For example, each data value may include a color expression such as red, green, and blue (RGB) or luminance, blue chrominance, and red chrominance (YUV). RGB may be a color expression using red, green, and blue, and YUV may be a color expression using luminance, blue chrominance, and red chrominance. Hereinafter, examples are described in which each data value is expressed in the RGB format, but embodiments are not limited thereto. For example, the first data values 341 may be expressed as (r, g, b).

For example, in response to an input of the second coordinate 312, the first neural field model 321 may generate second data values 342 corresponding to the second coordinate 312. For example, in response to an input of the first coordinate (x, y) 311, the second neural field model 322 may generate first data values 351 corresponding to the first coordinate (x, y) 311. The first data values 351 may be expressed as (r′, g′, b′). For example, in response to the input of the second coordinate 312, the second neural field model 322 may generate second data values 352 corresponding to the second coordinate 312.

The original dataset 301 and the test dataset 330 may each be input to the same neural test model 360. In an embodiment, the neural test model 360 may be trained based on the original dataset 301, and also may be separately trained based on the test dataset 330. In an embodiment, the neural test model 360 may be a feature extractor model for comparing feature distributions of the original dataset 301 and the test dataset 330. Distillation loss 361 may be determined based on inputs of the original dataset 301 and the test dataset 330 to the neural test model 360. A training procedure 362 may be performed on the plurality of neural field models 320 based on the distillation loss 361. The training procedure 362 may be performed to reduce the difference between a function of the test dataset 330 generated by the plurality of neural field models 320 as a training dataset and a function of the original dataset 301 as a training dataset.

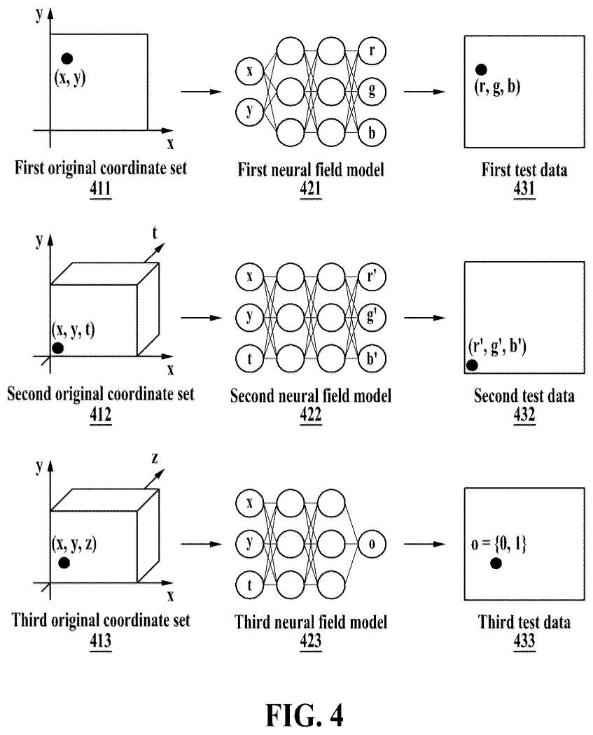

FIG. 4 is a diagram illustrating an example of a process for generating test data based on the type of original data, according to an embodiment. Referring to FIG. 4, for dataset distillation, a first original coordinate set 411, a second original coordinate set 412, and a third original coordinate set 413 may be input to neural field models, respectively. The first original coordinate set 411 may correspond to a case in which a corresponding original dataset is a set of pieces of two-dimensional (2D) image data. For example, the first original coordinate set 411 may be a set of pieces of 2D image data for training an object classification model.

The second original coordinate set 412 may correspond to a case in which a corresponding original dataset is a set of pieces of video data including time information. For example, the second original coordinate set 412 may be a set of pieces of video data for training an object-tracking model based on a recurrent neural network (RNN). The third original coordinate set 413 may correspond to a case in which a corresponding original dataset is a set of three-dimensional (3D) pieces of image data. For example, the third original coordinate set 413 may be a 3D voxel dataset for training a 3D modeling model such as a neural radiance field (NeRF).

A first neural field model 421 may be used to perform a dataset distillation process on an original dataset corresponding to the first original coordinate set 411. The first neural field model 421 may receive a coordinate (x, y) of the first original coordinate set 411 and output data values (r, g, b) corresponding to the coordinate (x, y). For example, the data values (r, g, b) may be RGB color values corresponding to the coordinate (x, y). First test data 431 may include output values of the first neural field model 421 corresponding to all coordinates of the first original coordinate set 411.

A second neural field model 422 may be used to perform a dataset distillation process on an original dataset corresponding to the second original coordinate set 412. The second neural field model 422 may receive a coordinate (x, y, t) of the second original coordinate set 412 and output data values (r′, g′, b′) corresponding to the coordinate (x, y, t). For example, the data values (r′, g′, b′) may be RGB color values corresponding to the coordinate (x, y, t). Second test data 432 may include output values of the second neural field model 422 corresponding to all coordinates of the second original coordinate set 412.

A third neural field model 423 may be used to perform a dataset distillation process on an original dataset corresponding to the third original coordinate set 413. The third neural field model 423 may receive a coordinate (x, y, z) of the third original coordinate set 413 and output a data value o corresponding to the coordinate (x, y, z). For example, the data value o may be an occupancy value corresponding to the coordinate (x, y, z). The occupancy value may be a value indicating whether a 3D space is filled and may correspond to a value of zero (“0”) or a value of one (“1”). Third test data 433 may include output values of the third neural field model 423 corresponding to all coordinates of the third original coordinate set 413.

As shown in FIG. 4, because the original coordinate set may be easily obtained from various types of original datasets, the computational costs to obtain the original coordinate set may not be large even when the original data of the original dataset is high-dimensional data. In addition, even when the original data of the original dataset is high-dimensional data, only the first layer of the neural field models may be structurally affected, so the storage costs to store the parameters of the neural field models and the computational costs to output the data values may not increase significantly. Accordingly, even when the original data of the original dataset is high-dimensional data, dataset distillation that uses the neural field models may be easily applied.

FIG. 5 is a flowchart illustrating an example of a method of training an AI model using a distilled dataset, according to an embodiment. Referring to FIG. 5, at operation 510, an original coordinate set may be obtained. At operation 520, a test dataset may be generated by inputting the original coordinate set to a plurality of neural field models. At operation 530, the plurality of neural field models may be trained based on an original dataset and the test dataset. In some embodiments, operations 510 to 530 may correspond to operations 210 to 230 of FIG. 2.

At operation 540, a distilled dataset may be generated by inputting an input coordinate set to the plurality of neural field models. The input coordinate set may be selected from among a plurality of candidate coordinate sets. The candidate coordinate sets may include the original coordinate set. The input coordinate set may include a plurality of coordinates.

Each neural field model from among the plurality of neural field models may receive the input coordinate set as an input. For example, each neural field model from among the plurality of neural field models may receive each coordinate included in the input coordinate set. Each neural field model from among the plurality of neural field models may generate distilled data based on the input coordinate set. The distilled dataset may include a plurality of pieces of distilled data corresponding to the input coordinate set. Because each neural field model from among the plurality of neural field models may generate one piece of distilled data in response to the input coordinate set, the number of pieces of distilled data included in the distilled dataset may be the same as the number of neural field models included in the plurality of neural field models.

Each neural field model from among the plurality of neural field models may generate one or more data values corresponding to each coordinate, based on each coordinate included in the input coordinate set. For example, in response to an input of a first coordinate included in the input coordinate set, each neural field model from among the plurality of neural field models may generate one or more first data values corresponding to the first coordinate. The distilled data corresponding to the input coordinate set may include one or more data values corresponding to each coordinate included in the input coordinate set. For example, all pieces of distilled data of the distilled dataset may include one or more data values corresponding to the first coordinate. Because the coordinates of the distilled data, which may be spaces in which information of the distilled data is stored, correspond to the coordinates of the input coordinate set, the number of data values included in the distilled data may correspond to the number of coordinates included in the input coordinate set.

The process for determining the input coordinate set may not generate additional storage costs. As the number of coordinates included in the input coordinate set increases, the resolution of the distilled data may increase without generating additional storage costs. The smaller the number of coordinates included in the input coordinate set, the lower the resolution of the distilled data may be without generating additional storage costs. The resolution of the distilled data may refer to the size of data.

Even when the input coordinate set is not the same as the original coordinate set, the distilled data may be generated without changing weights of the neural field models. Because the input coordinates of the trained neural field models may have consecutive values, a corresponding data value may be output even when a coordinate not included in the original coordinate set, which is used in the training process for training the neural field models, is input to the neural field models. Accordingly, the process for generating the distilled data having a resolution that is different from the original data may not require additional size adjustment of the original data. Because the size of the original data may not be adjusted, distortion or loss of information of the original dataset may not occur in the process for generating the distilled dataset including data having a resolution that is different from the original dataset.

At operation 550, a target model may be trained based on the distilled dataset. The target model may be a model that may be trained based on the original dataset. When the input coordinate set is the original coordinate set, the target model trained based on the distilled dataset may exhibit substantially similar performance to the target model trained based on the original dataset.

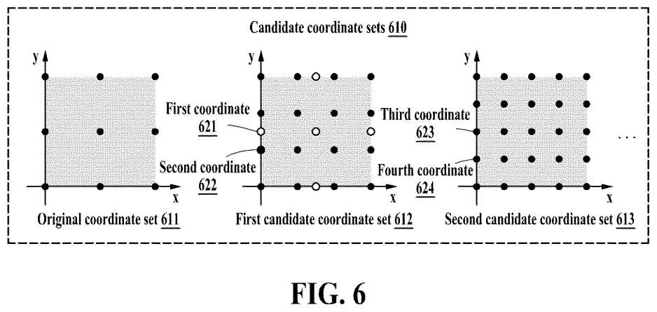

FIG. 6 is a diagram illustrating an example of candidate coordinate sets, according to an embodiment. Referring to FIG. 6, a plurality of candidate coordinate sets 610 may include an original coordinate set 611, a first candidate coordinate set 612, and a second candidate coordinate set 613. Although two types of candidate coordinate sets are illustrated in FIG. 6, the first candidate coordinate set 612 and the second candidate coordinate set 613 are examples, and the number of candidate coordinate sets included in the plurality of candidate coordinate sets 610 is not limited thereto.

A candidate coordinate set from among the plurality of candidate coordinate sets 610 may not include any coordinate of the original coordinate set 611. For example, the white coordinate of the first candidate coordinate set 612 may be a coordinate included in the original coordinate set 611 and not included in the first candidate coordinate set 612. For example, a first coordinate 621 may be a coordinate of the original coordinate set 611 and not included in the first candidate coordinate set 612. The candidate coordinate set from among the plurality of candidate coordinate sets 610 may include any coordinate of the original coordinate set 611. For example, a third coordinate 623 of the second candidate coordinate set 613 may be a coordinate of the original coordinate set 611. The candidate coordinate set from among the plurality of candidate coordinate sets 610 may include any coordinate that is not included in the original coordinate set 611 between the coordinates of the original coordinate set 611. For example, a second coordinate 622 of the first candidate coordinate set 612 and a fourth coordinate 624 of the second candidate coordinate set 613 may be coordinates not included in the original coordinate set 611.

In the example shown in FIG. 6, a number of coordinates of the original coordinate set 611 may be 9, a number of coordinates of the first candidate coordinate set 612 may be 16, and a number of coordinates of the second candidate coordinate set 613 may be 25. When the first candidate coordinate set 612 is an input coordinate set, the resolution of distilled data of a distilled dataset may be higher than when the original coordinate set 611 is the input coordinate set. When the second candidate coordinate set 613 is the input coordinate set, the resolution of the distilled data of the distilled dataset may be higher than when the first candidate coordinate set 612 is the input coordinate set.

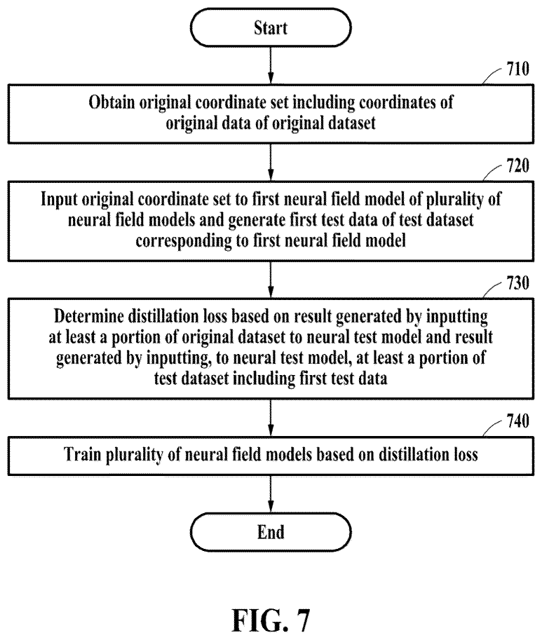

FIG. 7 is a flowchart illustrating an example of a method of dataset distillation, according to an embodiment. Referring to FIG. 7, at operation 710, an electronic device may obtain an original coordinate set including coordinates of original data of an original dataset.

At operation 720, the electronic device may input the original coordinate set to a first neural field model of a plurality of neural field models and generate first test data of a test dataset corresponding to the first neural field model. The electronic device may input a first coordinate of the original coordinate set to the first neural field model and generate a first data value of the first test data corresponding to the first coordinate. The electronic device may input the original coordinate set to a second neural field model from among the plurality of neural field models and generate second test data of the test dataset corresponding to the second neural field model.

At operation 730, the electronic device may determine distillation loss based on a result generated by inputting at least a portion of the original dataset to a neural test model and a result generated by inputting, to the neural test model, at least a portion of the test dataset including the first test data.

At operation 740, the electronic device may train the plurality of neural field models based on the distillation loss. The electronic device may input, to the plurality of neural field models, an input coordinate set selected from candidate coordinate sets including the original coordinate set and may generate a distilled dataset including distilled data corresponding to each neural field model from among the plurality of neural field models. The electronic device may input a second coordinate included in the input coordinate set to the plurality of neural field models and generate a data value of the distilled dataset corresponding to the second coordinate. The number of data values included in each piece of distilled data included in the distilled dataset may correspond to the number of coordinates included in the input coordinate set. The number of pieces of distilled data included in the distilled dataset may be the same as the number of neural field models included in the plurality of neural field models.

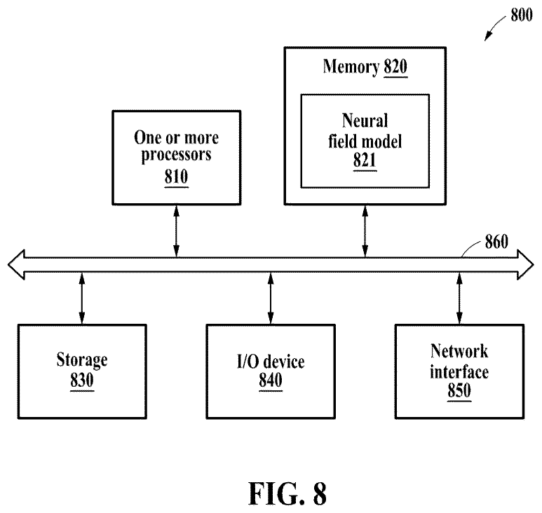

FIG. 8 is a block diagram illustrating a configuration of an electronic device for distilling a dataset, according to an embodiment. An electronic device 800 may include one or more processors 810, a memory 820, a storage 830, an input/output (I/O) device 840, and a network interface 850. These components may communicate with each other using a communication bus 860. The electronic device 800 may be implemented as at least one of, for example, a mobile device, such as a mobile phone, a smartphone, a personal digital assistant (PDA), a netbook, a tablet computer, a laptop computer, and the like, a wearable device, such as a smartwatch, a smart band, smart glasses, and the like, a computing device, such as a desktop, a server, and the like, a home appliance, such as a television (TV), a smart TV, a refrigerator, and the like, a security device, such as a door lock and the like, and a vehicle, such as an autonomous vehicle, a smart vehicle, and the like.

The one or more processors 810 may execute instructions stored in the memory 820 or the storage 830. The instructions, when executed by the one or more processors 810, may cause the electronic device 800 to perform operations described with reference to FIGS. 1 to 7. The memory 820 may include a non-transitory computer-readable storage medium or a non-transitory computer-readable storage device. The memory 820 may store instructions to be executed by the one or more processors 810 and may store related information while software and/or applications are being executed by the electronic device 800. The memory 820 may store a neural field model 821 according to an embodiment. With at least a portion of the neural field model 821 stored in the memory 820, the electronic device 800 may perform operations described with reference to FIGS. 1 to 7.

The storage 830 may include a non-transitory computer-readable storage medium or a non-transitory computer-readable storage device. The storage 830 may store a greater amount of information than the memory 820 for a longer period of time. For example, the storage 830 may include a magnetic hard disk, an optical disk, flash memory, a floppy disk, or other non-volatile memories known in the art.

The I/O device 840 may receive an input from a user using a keyboard and a mouse, or using a touch input, a voice input, and an image input, or using any other type of input. For example, the I/O device 840 may include at least one of a keyboard, a mouse, a touch screen, a microphone, and any other device for detecting the input from the user and transmitting the detected input to the electronic device 800. The I/O device 840 may provide an output of the electronic device 800 to the user using a visual, auditory, or haptic channel. The I/O device 840 may include, for example, at least one of a display, a touch screen, a speaker, a vibration generator, and any other device for providing the output to the user. The network interface 850 may communicate with an external device through a wired or wireless network.

The units described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be stored in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher-level code that can be executed by the computer using an interpreter.

The above-described devices may be configured to act as one or more software modules in order to perform the operations of the above-described embodiments, or vice versa.

A number of embodiments are described above. However, it should be understood that various modifications can be made to these embodiments. For example, suitable results may be achieved without departing from the scope of the disclosure if the described techniques are performed in a different order and/or if components in a described system, architecture, device, or circuit are combined in a different manner and/or replaced or supplemented by other components or their equivalents.

Therefore, other implementations, other embodiments, and equivalents to the claims are also within the scope of the following claims.

What is claimed is:

1. A distillation method comprising:
obtaining an original coordinate set comprising coordinates of original data included in an original dataset;
generating first test data included in a test dataset corresponding to a first neural field model from among a plurality of neural field models by providing the original coordinate set to the first neural field model;
obtaining a first result by providing at least a portion of the original dataset to a neural test model;
obtaining a second result by providing at least a portion of the test dataset comprising the first test data to the neural test model;
determining a distillation loss based on the first result and the second result; and
training the plurality of neural field models based on the distillation loss.

2. The distillation method of claim 1, wherein the generating of the first test data comprises:
generating a first data value corresponding to a first coordinate from among the original coordinate set by providing the first coordinate to the first neural field model.

3. The distillation method of claim 1, further comprising:
generating a distilled dataset comprising distilled data corresponding to each neural field model from among the plurality of neural field models by providing, to the plurality of neural field models, an input coordinate set selected from among a plurality of candidate coordinate sets comprising the original coordinate set.

4. The distillation method of claim 3, wherein the generating of the distilled dataset comprises:
generating a data value corresponding to a second coordinate included in the input coordinate set by providing the second coordinate to the plurality of neural field models.

5. The distillation method of claim 4, wherein a number of data values included in each piece of distilled data included in the distilled dataset corresponds to a number of coordinates included in the input coordinate set.

6. The distillation method of claim 3, wherein a number of pieces of distilled data included in the distilled dataset is equal to a number of the plurality of neural field models.

7. The distillation method of claim 1, further comprising:
generating second test data corresponding to a second neural field model from among the plurality of neural field models by providing the original coordinate set to the second neural field model.

8. A training method comprising:
obtaining an original coordinate set comprising coordinates of original data included in an original dataset;
generating first test data included in a test dataset corresponding to a first neural field model from among a plurality of neural field models by providing the original coordinate set to the first neural field model;
obtaining a first result by providing at least a portion of the original dataset to a neural test model;
obtaining a second result by providing at least a portion of the test dataset comprising the first test data to the neural test model;
determining a distillation loss based on the first result and the second result;
training the plurality of neural field models based on the distillation loss;
generating a distilled dataset comprising distilled data corresponding to each neural field model from among the plurality of neural field models by providing, to the plurality of neural field models, an input coordinate set from among a plurality of candidate coordinate sets comprising the original coordinate set; and
training a target model based on the distilled dataset.

9. The training method of claim 8, wherein the generating of the first test data comprises:
generating a data value corresponding to a first coordinate included in the original coordinate set by providing the first coordinate to the first neural field model.

10. The training method of claim 8, wherein the generating of the distilled dataset comprises:
generating a data value corresponding to a second coordinate included in the input coordinate set by providing the second coordinate to the plurality of neural field models.

11. The training method of claim 10, wherein a number of data values included in each piece of distilled data included in the distilled dataset corresponds to a number of coordinates included in the input coordinate set.

12. The training method of claim 8, wherein a number of pieces of distilled data included in the distilled dataset is equal to a number of the plurality of neural field models.

13. The training method of claim 8, further comprising:
generating second test data corresponding to a second neural field model from among the plurality of neural field models by providing the original coordinate set to the second neural field model.

14. An electronic device comprising:
one or more processors; and
a memory configured to store instructions executable by the one or more processors,
wherein, the instructions, when executed by the one or more processors, cause the electronic device to:
obtain an original coordinate set comprising coordinates of original data included in an original dataset;
generate first test data included in a test dataset corresponding to a first neural field model from among a plurality of neural field models by providing the original coordinate set to the first neural field model;
obtain a first result by providing at least a portion of the original dataset to a neural test model,
obtain a second result by providing at least a portion of the test dataset comprising the first test data to the neural test model;
determine a distillation loss based on the first result and the second result, and
train the plurality of neural field models based on the distillation loss.

15. The electronic device of claim 14, wherein to generate the first test data, the instructions, when executed by the one or more processors, further cause the electronic device to:
generate a data value corresponding to a first coordinate included in the original coordinate set by providing the first coordinate to the first neural field model.

16. The electronic device of claim 14, wherein the instructions, when executed by the one or more processors, further cause the electronic device to:
generate a distilled dataset comprising distilled data corresponding to each neural field model from among the plurality of neural field models by providing, to the plurality of neural field models, an input coordinate set from among candidate coordinate sets comprising the original coordinate set.

17. The electronic device of claim 16, wherein to generate the distilled dataset, the instructions, when executed by the one or more processors, further cause the electronic device to:
generate a data value of the distilled dataset corresponding to a second coordinate included in the input coordinate set by providing the second coordinate to the plurality of neural field models.

18. The electronic device of claim 17, wherein a number of data values included in each piece of distilled data included in the distilled dataset corresponds to a number of coordinates included in the input coordinate set.

19. The electronic device of claim 16, wherein a number of pieces of distilled data included in the distilled dataset is equal to a number of the plurality of neural field models.

20. The electronic device of claim 14, wherein the instructions, when executed by the one or more processors, further cause the electronic device to:
generate second test data of the test dataset corresponding to a second neural field model from among the plurality of neural field models by providing the original coordinate set to the second neural field model.
